(19) United States
(12) Patent Application Publication
(10) Pub. No.: US 2020/0131088 A1
(43) Pub. Date: Apr. 30, 2020

(54) CELLULOSE FLAKES, RELATED MANUFACTURING METHOD AND BINDING COMPOUND INCORPORATING SAME

(71) Applicant: Rafael Musiello Vieira, Rio de Janeiro (BR)

(72) Inventor: Rafael Musiello Vieira, Rio de Janeiro (BR)

(21) Appl. No.: 16/629,306

(22) PCT Filed: Jul. 6, 2018
(86) PCT No.: PCT/BR2018/050226

§ 371 Date: Jan. 7, 2020

(30) Foreign Application Priority Data
Jul. 7, 2017 (BR) 10 2017 014789 4

(51) Int. Cl. C04B 16/02; C04B 18/24; D21B 1/10

(52) U.S. Cl. CPC C04B 16/02; D21B 1/10; C04B 18/24

(57) ABSTRACT

The present invention relates to cellulose flakes obtained by grinding Kraft paper from discarded packing from construction work, a manufacturing method for said cellulose flakes and a binding compound incorporating said flakes. The aforementioned cellulose flake improves the mechanical properties of any product obtained using the same, for example, mortars and concretes.

### CROSS REFERENCE TO RELATED APPLICATIONS INFORMATION

The present application is a U.S. national stage patent application, pursuant to 35 U.S.C. § 371, of PCT International Application No. PCT/BR2018/050226, filed Jul. 6, 2018, published as WO2019/006531A1, which claims priority to Brazilian application No. BR 10 2017 014789-4, filed Jul. 7, 2017, granted as BR 10 2017 014789-4 B1, the contents of all of which are hereby incorporated by reference in their entirety.

### TECHNICAL FIELD

The present invention relates to cellulose flakes obtained from Kraft paper packing used in construction, to a manufacturing method of said cellulose flakes and to a binding compound comprising such flakes. The present invention relates to the field of construction.

### BACKGROUND

Concern for the environment is gaining momentum on the agenda of countries, which create laws to regulate the waste generation and disposal. All this work is due to the awareness that it is necessary to reduce waste generation through reuse and recycling of materials.

Construction is one of the sectors that generate the most waste, and hence the need to introduce reuse practices to minimize the current situation. Among the main wastes generated by construction are cement and lime packaging, in addition to Kraft paper bags, which are present in all types of work and in large volume (Santos and Carvalho, 2011) [1].

An efficient method for reusing Kraft paper bags is a solution that has long been sought, as can be seen from the numerous patent documents from research in the area, as mentioned below.

Document PI 0605985-6 addresses the problem of lack of recycling of cement bags from construction and refers to a method for manufacturing a composite obtained by reusing and/or recycling sacks of cement and mortar. This method is characterized by using recycling blades of Kraft paper pieces and Portland cement cream with commercial glue and might be used to produce flat or curved, industrial or handcraft plates. The method under consideration consists of crushing the discarded bags with the addition of water, followed by drainage of excess water, molding, and suction of the obtained plate, subsequent pressing, and drying of the plates.

Document WO 2016/077901 addresses the problem of lack of recycling of paper bags and refers to a method of reusing this type of material. This invention relates to the reuse of Kraft paper bags or the like, notably used as disposable packaging of different products, such as binders in general, mainly cement, lime, mortar, and plaster. This document aims to recycle the constituent paper of the bag for the manufacture of new materials and the recycling method involves a water addition step.

Document U.S. Pat. No. 5,350,451 proposes to solve the problem of paper waste accumulation and claims a building material made from the use of recycled paper and the method for manufacturing it. According to the specification, a pulp made of paper fibers, water, and cement might be used for a variety of construction applications. After draining most of the water, the sludge obtained may be molded into blocks, sheets, or any other shape desired for use as a building material or might be sprayed into wire forms to form other structures. The slurry product might be used in conjunction with building blocks that are made from the slurry. Such sludge can also be used as a plaster when mixed with cement, conventional mortar, and sand.

Document BR 10 2013 021313-6, like the previous one, proposes to solve the problem of accumulation of paper cement bags as waste and reveals a method of obtaining pallets from the recycling of Kraft paper from these bags and another packaging. Page 2 of the document reveals the existence of other projects also aimed at the recycling of cement bags, including the development of lining boards by crushing the bags, their cold pressing and subsequent drying of the plates in greenhouses at 100° C.

The purpose of document PI 1104067-0 is to provide panels without metal elements and, to this end, reveals a self-supporting panel with EPS core (expanded polystyrene) and mortar reinforced with plasticizing additives and recycled cellulose fibers, in addition to its manufacturing method. According to the document, recycled cellulose fibers can be, among others, Kraft paper bags. According to the information on page 6 of that document, the mortar is prepared by adding, in a proper mixer, the cement, fine sand in varying proportion (according to the desired strength in relation to the weight between half and three parts of sand for each part of cement), recycled and unpaved cellulose fibers (in the proportion of one to fifteen percent by mass) and water in varying proportions according to the moisture content of the sand, having as an ideal pattern a viscous, adherent and homogeneous mortar.

Although the present invention also makes reference to the reuse of mortar and/or cement sacks, it differs from the above documents in that it presents a method of reusing Kraft paper as a cellulose flake in binding compounds, besides describing an innovative manufacturing method of such a flake, which does not require the addition of water.

The present invention has as main relevant contributions to the prior art:

(i) maintaining the traditional method of construction, without the need for further adjustments that would not be of interest due to the cost involved;
(ii) maintaining the supply of bagged material; and
(iii) the possibility of reusing packaging waste, which sets it apart from other companies operating in this segment, which recommend the incineration of this waste.
(iv) reduction of cracks when applied to mortar, which brings mechanical benefits such as increased bond strength.

### SUMMARY OF THE INVENTION

In a first aspect, the present invention provides a cellulose flake which confers improved mechanical properties on any product obtained from its use, such as, but not limited to, mortar and concrete.

An object of the present invention is to provide a cellulose flake having an average diameter of less than 5,000 μm, preferably 3,500 μm, comprising cellulose fibers. In particular, the cellulose fibers are obtained from paper, preferably Kraft paper.

In the best embodiment, the cellulose flakes are obtained from recycled Kraft paper, in particular, the Kraft paper used in sacks of construction products such as cement or mortar bags.

An additional object of the present invention is to provide a manufacturing method of cellulose flakes comprising the steps of:

(a) grinding the starting material; and
(b) selection of particles having a diameter of less than 5,000 μm.

In the best embodiment, grinding of the starting material takes place in a knife mill, more preferably a wedge-shaped stepped sequential knife system.

In the best embodiment, particle selection is by means of screens or sieves with suitable openings to obtain the desired size. In particular, the screen used is a 5 mm screen.

In another embodiment, the present invention provides a binding compound comprising the cellulose flake.

An object of the present invention is to provide a binding compound comprising the cellulose flakes in a concentration ranging from 0.1% to 2.0% by weight of the compound.

In the best embodiment, the binding compound comprises:

(a) 0.1% to 2.0% by weight of a cellulose flake;
(b) a cement and/or another binder; and
(c) a filler and/or mineral fillers.

These and other objects of the present invention will be detailed in the following figures and description.

### BRIEF DESCRIPTION OF THE FIGURES

FIG. 1 shows a photo of a knife mill used for grinding the starting material according to the present invention. The wedge-shaped stepped sequential knife system, which is responsible for perfectly grinding, might be observed.

FIG. 2 shows a photo obtained by electron microscopy of the recycled paper process after the knife grinding process and selection of flakes from a 5 mm screen.

FIG. 3 shows a photo of the assembly and instrumentation of the assays of (a) uniaxial compression, (b) bending at four points and (c) pullout.

FIG. 4 shows a photo of the experimental arrangement of the restriction shrinkage assay according to the ASTM (American Society for Testing and Materials) C1581 standard.

FIG. 5 shows a photo of mortars applied to the wall of the Fluency and Shrinkage laboratory (PUC-Rio).

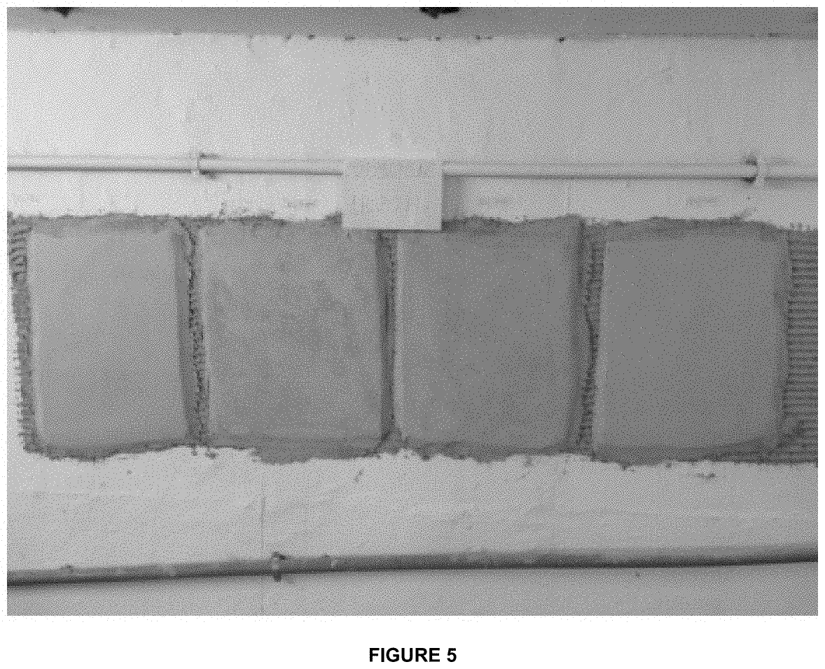

FIG. 6 shows a photographic comparison of applications:

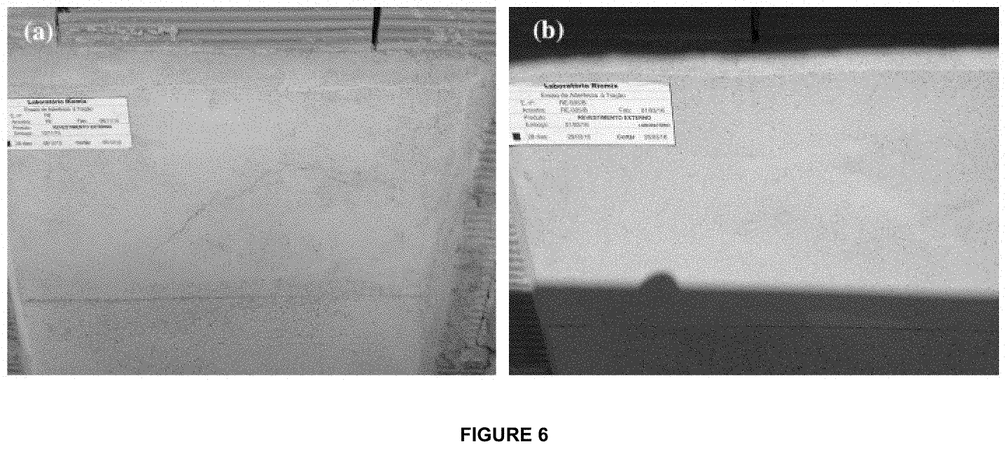

(a) a coating mortar (with HPMC (hydroxypropyl methylcellulose) additive) without the addition of cellulose flakes; and
(b) a mortar with 0.3% by weight of cellulose flake according to the present invention and without the inclusion of HPMC additive.

FIG. 7 shows the shrinkage curves according to ASTM C1581 standard.

FIG. 8 shows photos of crack formation in the shrinkage assay, zoomed in to one of the cracks in each sample according to ASTM C1581 standard:

(a) reference sample without HPMC and without cellulose flakes;
(b) HPMC reference sample;
(c) sample with the addition of 0.3% by weight of cellulose flakes; and
(d) sample with the addition of 0.6% by weight of the cellulose flake.

FIG. 9 shows photos of the Fluminense Football Club training center, where mortar with addition of 0.3% cellulose flake was used as internal and external coating: (a and b) photos of the sector 4 facade—during and after construction, (c) photo of gym—during and after construction, and (d) internal photo showing the perfect finishing of the mortar.

### DETAILED DESCRIPTION OF THE INVENTION

The examples shown here are intended merely to illustrate some of the numerous embodiments of the present invention and should not be construed as limiting the scope of the present invention, but merely to exemplify a large number of possible embodiments.

Minor modifications in quantities or parameters that achieve the results proposed by the present invention should be understood to be within the scope of the invention.

### Cellulose Flakes

An object of the present invention is to provide a cellulose flake having an average diameter of less than 5,000 μm, preferably 3,500 μm, comprising cellulose fibers. In particular, the cellulose fibers are obtained from paper, preferably Kraft paper.

In a preferred embodiment, the cellulose flakes are obtained from recycled Kraft paper, in particular, the Kraft paper used in sacks of construction products such as cement or mortar bags.

### Manufacturing Method of Cellulose Flake

The manufacturing method of cellulose flakes of the present invention comprises the steps of:

(a) grinding the starting material; and
(b) selection of particles having a diameter of less than 5,000 μm.

The grinding step is intended to decrease the particle size of the starting material, thereby facilitating its incorporation into the binding compound. Any type of grinding known in the art may be used. In a preferred embodiment, grinding of the material takes place in a knife mill, more preferably a wedge-shaped stepped sequential knife system.

The grinding starting material is a material containing cellulosic fibers, such as paper. Preferably, Kraft paper is used as a starting material. In a preferred embodiment, Kraft paper is obtained from already used cement and/or mortar bags, thus contributing to the use of construction waste and an environmentally friendly logistics operation.

In one embodiment, particle selection is by means of screens or sieves with suitable openings to obtain the desired size. In particular, the screen used is a 5 mm screen.

### Binding Compound

The present invention further provides a binding compound comprising:

(a) 0.1% to 2.0% by weight of a cellulose flake;
(b) a cement and/or another binder; and
(c) a filler and/or mineral fillers.

The compound according to the present invention might be in the form of grain, being referred to as a dry compound, or might be in the form of a dispersion, in which its consistency is pasty, as in ready-to-use mortars.

Non-limiting examples of types of cement useful in accordance with the present invention include mineral types of cement and synthetic types of cement. Examples of mineral types of cement include, without limitation, Portland cement, high alumina cement, sulfoaluminate cement, bellicose cement, pozzolanic cement, which may be used individually or in combination. Examples of synthetic types of cement include, without limitation, acrylic and/or vinyl polymers or copolymers, styrene and butadiene copolymers, styrene and acrylic acid copolymers, vinyl and ethylene acetate copolymers, vinyl acetate and vinyl versatate copolymers, and derivatives thereof. Other binders that may be used in the present invention include, without limitation, geopolymers and (glazed) slag.

Non-limiting examples of fillers used in the compound of the present invention include, without limitation, sands and/or fillers of limestone and/or siliceous origin, gravel, boulder, natural sands, industrial sands, and clay sands.

The binding compound may further contain other cement adjuvant compositions, filler and cellulose flakes. Such adjuvants are intended to impart additional properties to the compound without compromising mechanical properties and to have the same improved proprieties with the inclusion of the cellulose flake described herein.

Non-limiting examples of adjuvant compositions include pigments, waterproofing agents, thickeners, preservatives, viscosity modifiers, corrosion inhibitors, and flame retardants.

### EXAMPLES

The following examples are intended to report the results of mechanical (compression, bending on prismatic specimens, tensile bonding, and durability) and shrinkage assays performed on reference mortar and binding compounds with the cellulose flake of the present invention (at concentrations of 0.3% and 0.6% by weight) obtained by passing through 5 mm screens.

### Production of Cellulose Flakes

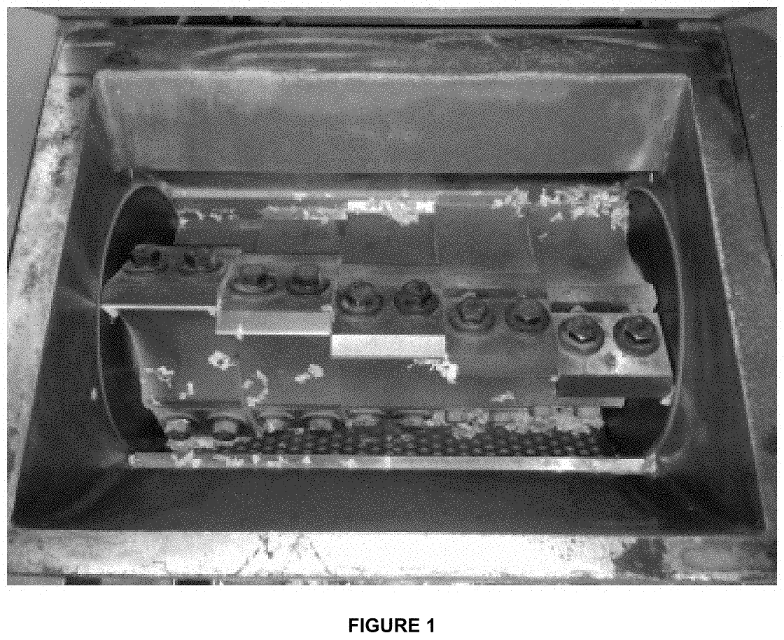

The mortar bags (starting material) were crushed in a knife mill according to FIG. 1. Then the crushed material was passed through 2 mm, 5 mm and 10 mm screens and embedded in concentrations of 0.3% and 0.6% by weight in the formulations studied.

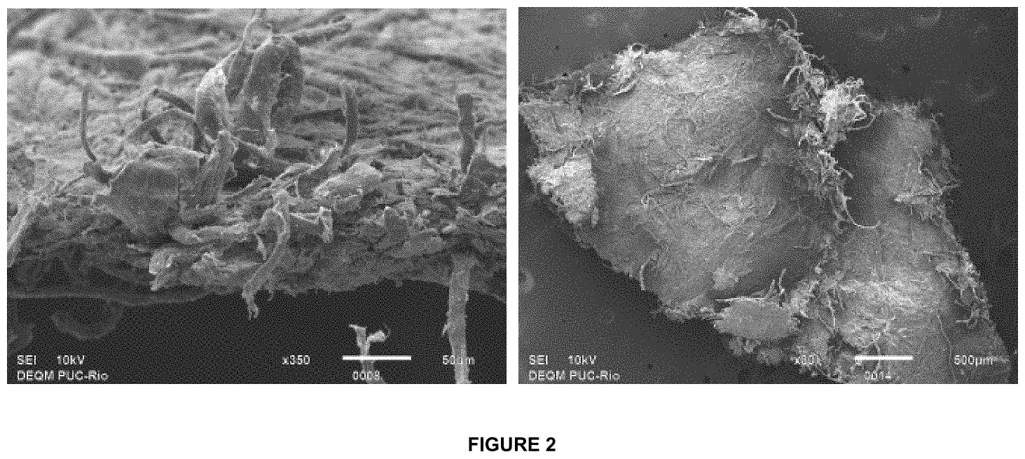

FIG. 2 shows a micrograph of the cellulose flakes obtained after the grinding process with 5 mm screens, containing cellulosic fibers with approximately 100 μm thickness and 3,500 μm equivalent diameter.

### Preliminary Assays to Choosing Cellulose Flake Size: Compression and Bending Assays

The mortar used in the assays of the present invention was produced in a TNZ 1500 TURBO MIXER planetary type mixer, following the dosage is shown in Table 1. The Riomix outer coat (multiuse) base coating with the addition of (hydroxypropyl methylcellulose) meilose GMC 1150 with an average particle size of less than 149 μm. Such an additive also is known as HPMC, is a cellulose-derived polymer with high wetting capacity and high hydration rate. In concrete or mortar, its function is to improve dough consistency and increase water retention.

TABLE 1
Material consumption for the production of mortar

| | Reference | | | | | |
|---|---|---|---|---|---|---|
| Materials | 0 | | A | | B | |
| Mortar* | 1.5 | Kg | 1.5 | Kg | 1.5 | Kg |
| Water | 285 | mL | 285 | mL | 285 | mL |
| Cellulose flakes | 0 | | 4.5 | g (0.3%) | 9.0 | g (0.6%) |
| Meilose GMC | 0.01 | mass % | 0.01 | mass % | 0.01 | mass % |
| 1150* | | | | | | |

*12% Portland CPII32 E cement; 13.3% limestone filler; 74.09% to 74.7% industrial sand.

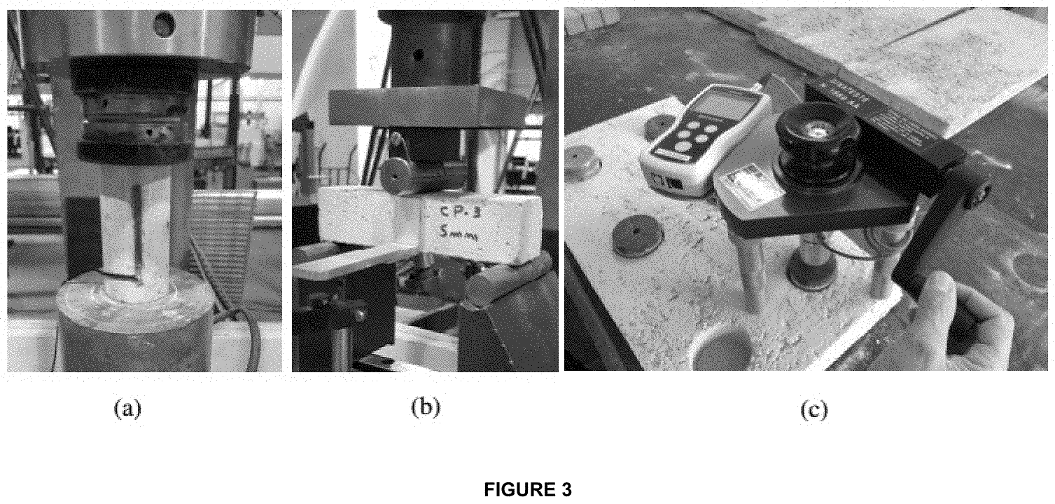

Three essays of uniaxial compression and three-point flexion at 28 days of each formulation were performed. All tests were performed on MTS universal controlled testing system with a load capacity of 500 kN. Compression assays were performed by force control at a rate of 0.3 MPa/s on 50×100 mm cylindrical specimens. For comparison, compression assays were also performed on 40 mm×40 mm section prisms according to NBR 13279 [2]. Displacement was measured by extensometers glued to the central region of the specimen (see FIG. 3a). Deformations and applied loading were recorded by an HBM data acquisition system.

Table 2 presents the compression results performed on the HPMC additive traces and inclusions of the cellulose flakes in different lengths and percentages. For the compression assays performed on 50 mm×100 mm cylinders, formulations with cellulose flake inclusion showed a reduction in compressive strength.

TABLE 2
Mean and standard deviation of uniaxial compression results performed
on 50 mm × cylinders, at day 28. Mixtures with HPMC additive

| Fiber length | | Maximum load | | Maximum stress | |
|---|---|---|---|---|---|
| (mm) | Mixture | (kN) | | (MPa) | |
| Reference | 0 | 15.73 | (1.5) | 8.03 | (0.76) |
| 2 | A | 14.28 | (2.31) | 7.29 | (1.18) |
| | B | 12.79 | (0.17) | 6.53 | (0.08) |
| 5 | A | 8.00 | (0.27) | 4.08 | (0.14) |
| | B | 9.15 | (1.04) | 4.66 | (0.53) |
| 10 | A | 6.84 | (0.17) | 3.49 | (0.086) |
| | B | 9.97 | (0.58) | 5.08 | (0.29) |

### Shrinkage Assays

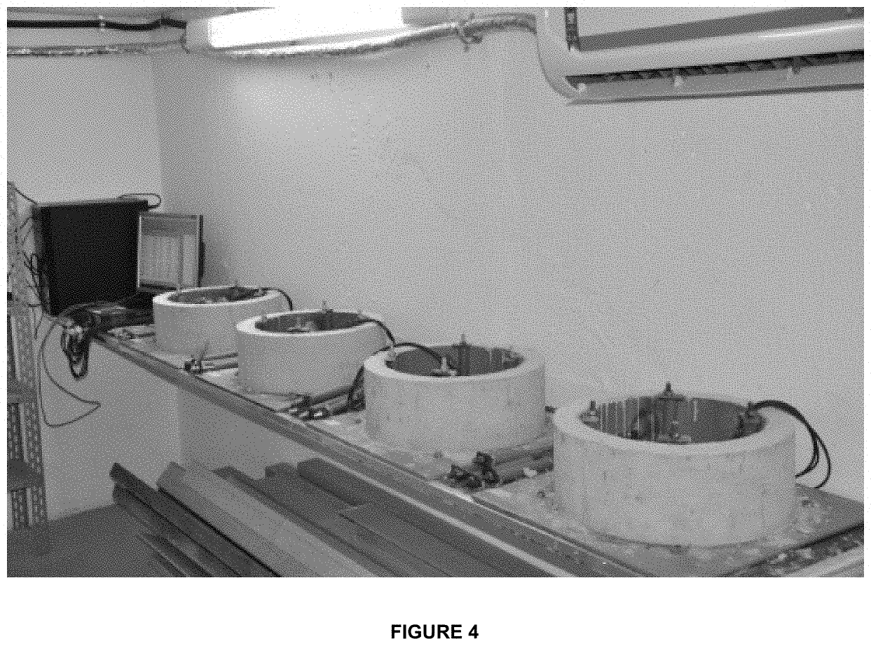

The shrinkage assay using steel ring restriction was conducted according to ASTM C1581 [3], in order to evaluate the cracking potential of mortars with and without cellulose flake. The assay was performed in an environment with controlled temperature and humidity (T=21±2° C., H=50±5%) and the samples were monitored over a period of 104 days. The apparatus used in the assay comprised a set of steel components comprising a square base, an inner ring (13 mm thickness, 330 mm outer diameter and 155 mm height) and an outer ring (9 mm thickness, 405 mm inner diameter and 155 mm height), this set being coupled to a HBM data acquisition system (FIG. 4). The inner ring acted as a passive constraint to the surrounding mixture.

As the mixing shrunk, it applied a uniform tension on the steel (inner ring), generating deformations therein. Simultaneously to this process, tensile stresses were induced in the sample due to the presence of the constraint (inner ring). When these stresses exceed the tensile strength of the material, cracking occurred and the deformation measured in the steel dropped. Extensometers were glued to the inner face of the inner ring along the circumference at half height and equidistantly. These extensometers were used to monitor deformations in the inner ring and were connected to a data acquisition system. After the assay, the crack opening was determined with the aid of an optical microscope.

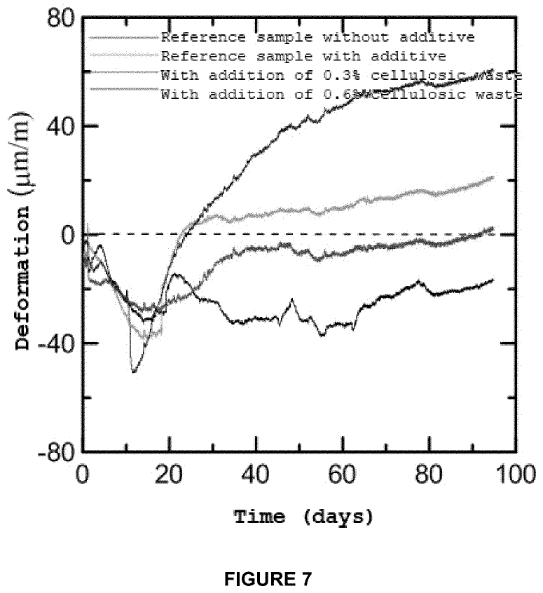

As shown in the curves of FIG. 7, as mixtures shrink, as shown by the drop in the deformation value of the graph, they exert uniform compressive stress on the ring, leading to the development of deformations therein. Simultaneously to the shrinkage tendency of the mixtures, tensile stresses were induced in the material by the presence of a passive constraint. When these tensile stresses exceeded the tensile strength of the material, a crack formed, which results in the deformation of the steel ring, evidenced by the shift in the curves of FIG. 7 where the deformation value then becomes increasing.

The reference sample without additive (blue line) shows a larger shrinkage of the mortar, evidenced by the smaller deformation value around day 10, shown in FIG. 7, followed by a sharp and continuous growth of this value until the end of the experiment, reaching the highest deformation values. This sharp growth is the formation of cracks in the sample, and the high deformation value means a large crack. In this case, the crack has an average length of 0.70 mm.

The sample containing only the additive (green line) shows a profile similar to the sample without additive. It was observed that the additive not only changes the time in which the crack occurs, extending from 10 days to almost 20 but also influences the shrinkage of the sample, providing a less negative deformation value when compared to the sample without additive. It was observed that there is crack formation by a sharp change of the deformation value, and the additive affects the deformation that the sample undergoes, decreasing the maximum deformation measured, consistent with the observed average crack of 0.58 mm.

The samples with the addition of cellulose flake (red and black lines in FIG. 7) showed superior performance in relation to cracking behavior under constrained conditions, not only delaying the cracking formation (point where the deformation value passes increasing), as we can see a longer time to reach the minimum value, as well as limiting their respective openings, as can be seen from the maximum deformation value reached after 100 days. The curves of the samples with the cellulose flakes are much smoother without sharp changes.

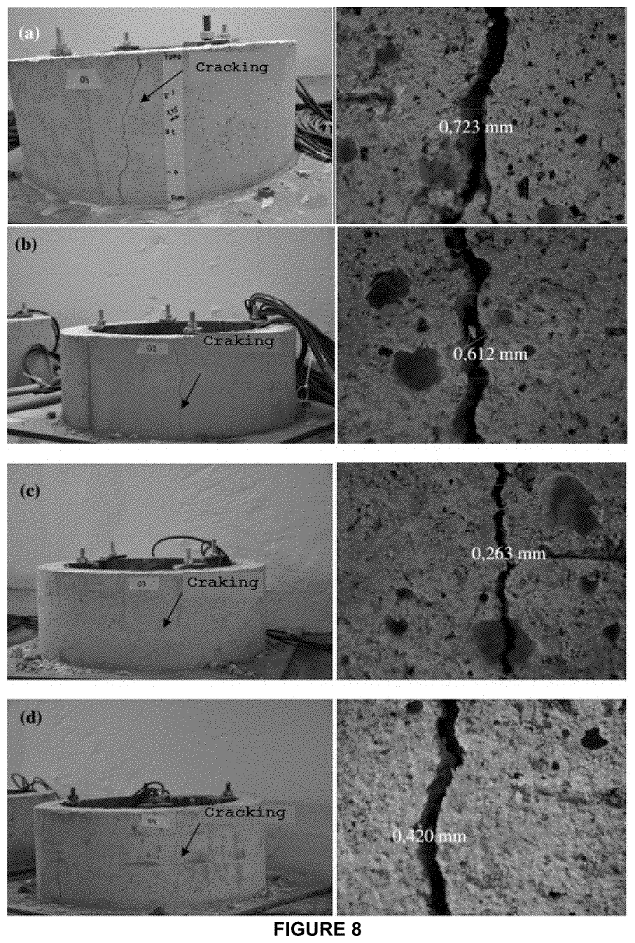

The sample with the addition of 0.3% cellulose flakes (red line) showed the best average performance, with crack formation only after 16 days and an average crack opening of 0.25 mm (see FIG. 8). The average crack openings were determined as the average of 5 cracks in different positions of the specimen, as shown in FIG. 8(a). The sample with the addition of 0.6% cellulose flakes (black line) shows very late crack formation. Only after 50 days that there is crack formation and the deformation values become increasing. Additionally, this sample presented the lowest final deformation value, which, in practice, means that the cracks generated are very small.

Table 3 shows the values of all the calculated crack openings.

TABLE 3
Crack openings determined at 5 different
positions according to FIG. 8 (a)

| | Crack opening (mm) | | | |
|---|---|---|---|---|
| | | | Without | Without |
| | Reference | Reference | HPMC and | HPMC and |
| | (without | (with HPMC | 0.3% | 0.6% |
| | HPMC and | and no | cellulose | cellulose |
| Position | no flakes) | flakes) | flakes | flakes |
| Top | 0.684 | 0.503 | 0.283 | 0.298 |
| 1 | 0.723 | 0.612 | 0.263 | 0.519 |
| 2 | 0.713 | 0.644 | 0.296 | 0.420 |
| 3 | 0.704 | 0.570 | 0.154 | 0.384 |
| Base | 0.680 | 0.572 | 0.249 | 0.404 |
| Mean | 0.700 | 0.580 | 0.250 | 0.400 |

In addition, it was found that for mixtures with cellulose flakes, cracking did not occur instantaneously but rather slowly. For mixtures without the addition of cellulose flake, the sharp drop of deformation of the steel ring occurred after 12 days of testing. This sharp drop is related to the crack opening at the full height of the specimen. Furthermore, the average crack opening was also much higher for mortars without the addition of cellulose flakes, always remaining above 0.5 mm (see FIG. 8).

### Case Study

The mortar with the addition of 0.3% cellulose flake resulting from the study of the present invention was used as an internal and external coating in construction of the Fluminense Football Club Training Center (CT Pedro Antonio). The CT, built-in Barra da Tijuca, Rio de Janeiro

(Av. Ayrton Senna, s/n) in August 2016 on the land of 39.3 m² was divided as follows:

(a) sector 1: support area (laundry, garage, storage for deposit materials);
(b) sectors 2 and 3: daily football routine (changing rooms, medical department, physiotherapy, strength training, swimming pools, and athletes' recovery); and
(c) sector 4: a six-story tower that will house the lodging area (hotel, administrative structure, press room, and dining hall).

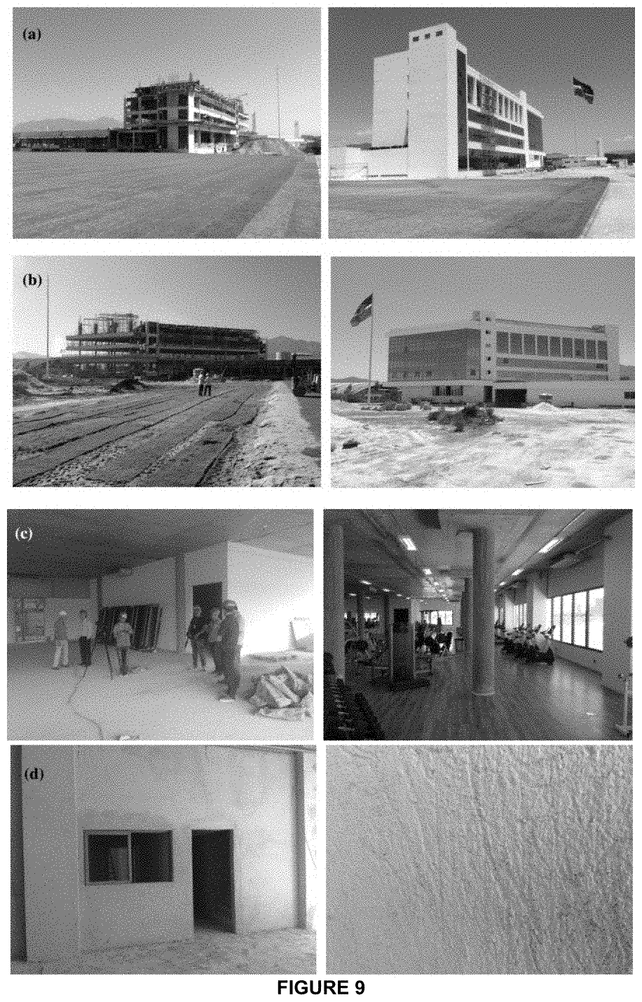

FIG. 9 shows photos of the construction in different stages and sectors. FIG. 9(a) and FIG. 9(b) show a photo of sector 4 in which the binding compound of the present invention was used as an external coating. During site visits, no cracking or other unusual behavior was noted. The finish is the same as the reference mortar, making it almost impossible to notice any difference by adding the cellulose flake.

FIG. 9(c) and FIG. 9(d) show parts of the gym where the binding compound with the addition of 0.3% cellulose flake was used as an internal coating. It is noticed (mainly in photo 9(d)) a perfect finish and no crack formation.

[1] Santos, L. R. e Carvalho, E. F.; “AVALIAÇÃO DE ARGAMASSAS COM FIBRAS DE PAPEL KRAFT PROVENIENTES DE EMBALAGENS DE CIMENTO”; Final graduation work, Federal University of Goiás, 2011.

[2] Associação Brasileira de Normas Técnicas. NBR 13279: Argamassa para assentamento e revestimento de paredes e tetos—Determinação da resistência à tração na flexão e à compressão. Rio de Janeiro, ABNT, 2005.

[3] ASTM C 1581 Standard Test Method for Determining Age at Cracking and Induced Tensile Stress Characteristics of Mortar and Concrete under Restrained Shrinkage.

The text in the PCT Figures is translated into English as follows:

FIG. 7

| | |
|---|---|
| Deformação (μm/m) | Deformation (μm/m) |
| Tempo (dias) | Time (days) |
| Referência sem aditivo | Reference without additive |
| Referência com aditivo | Reference with additive |
| Com adição de 0.3% de | With the addition of 0.3% |
| residuo celulósico | cellulosic waste |
| Com adição de 0.3% de | With the addition of 0.3% |
| residuo celulósico | cellulosic waste |

FIG. 8

| | |
|---|---|
| Fissura | Cracking |

1.-10. (canceled)

11. Cellulose flakes manufactured by a manufacturing method comprising:
(a) grinding paper by processing starting material in a knife mill; and
(b) sieving material resulting from step (a) in sieves to select particles, the sieves comprising a screen of a size no more than 5 mm;
wherein no water is required to perform the method and the paper is obtained from the recycling of Kraft paper packing used in construction.

12. The cellulose flakes of claim 11, wherein the cellulose flakes have an average diameter of less than 5,000 μm.

13. The cellulose flakes of claim 11, wherein the cellulose flakes have an average diameter of 3,500 μm.

14. The cellulose flakes of claim 12, wherein the cellulose flakes have an average diameter of 3,500 μm.

15. A binding compound comprising the cellulose flakes of claim 11, wherein the binding compound comprises:
0.1% to 2.0% by weight of the cellulose flakes;
12% by weight of cement and/or other binders; and
86% to 87.9% by weight of filler and/or mineral filler.

16. The binding compound of claim 15, wherein the cellulose flakes have an average diameter of less than 5,000 μm.

17. The binding compound of claim 16, wherein the cellulose flakes have an average diameter of 3,500 μm.

18. The binding compound of claim 15, wherein the cement and/or the other binders is selected from a group comprising Portland cement, high alumina cement, sulfoaluminate cement, bellicose cement, pozzolanic cement, acrylic and/or vinyl polymers or copolymers, styrene and butadiene copolymers, styrene and acrylic acid copolymers, vinyl and ethylene acetate copolymers, vinyl acetate and vinyl versatate copolymers, geopolymers and (glazed) slag, and combinations thereof.

19. The binding compound of claim 15, wherein the filler and/or mineral fillers is selected from a group comprising sands and/or fillers of limestone and/or siliceous origin, gravel, boulder, natural sands, industrial sands, clay sands, and combinations thereof.

20. The binding compound of claim 15, wherein the binding compound is in form of grains.

21. The binding compound of claim 16, wherein the cement and/or the other binders is selected from a group comprising Portland cement, high alumina cement, sulfoaluminate cement, bellicose cement, pozzolanic cement, acrylic and/or vinyl polymers or copolymers, styrene and butadiene copolymers, styrene and acrylic acid copolymers, vinyl and ethylene acetate copolymers, vinyl acetate and vinyl versatate copolymers, geopolymers and (glazed) slag, and combinations thereof.

22. The binding compound of claim 16, wherein the filler and/or mineral fillers is selected from a group comprising sands and/or fillers of limestone and/or siliceous origin, gravel, boulder, natural sands, industrial sands, clay sands, and combinations thereof.

23. The binding compound of claim 17, wherein the cement and/or the other binders is selected from a group comprising Portland cement, high alumina cement, sulfoaluminate cement, bellicose cement, pozzolanic cement, acrylic and/or vinyl polymers or copolymers, styrene and butadiene copolymers, styrene and acrylic acid copolymers, vinyl and ethylene acetate copolymers, vinyl acetate and vinyl versatate copolymers, geopolymers and (glazed) slag, and combinations thereof.

24. The binding compound of claim 17, wherein the filler and/or mineral fillers is selected from a group comprising sands and/or fillers of limestone and/or siliceous origin, gravel, boulder, natural sands, industrial sands, clay sands, and combinations thereof.

25. The binding compound of claim 16, wherein the binding compound is in form of grains.

26. The binding compound of claim 17, wherein the binding compound is in form of grains.

27. The binding compound of claim 18, wherein the binding compound is in form of grains.

28. The binding compound of claim 19, wherein the binding compound is in form of grains.

29. The binding compound of claim 21, wherein the binding compound is in form of grains.

30. The binding compound of claim 22, wherein the binding compound is in form of grains.

31. The binding compound of claim 23, wherein the binding compound is in form of grains.

32. The binding compound of claim 24, wherein the binding compound is in form of grains.
